(19) United States
(12) Patent Application Publication
(10) Pub. No.: US 2025/0207223 A1
(43) Pub. Date: Jun. 26, 2025

(54) NICKEL-BASED SUPERALLOY

(71) Applicants: SAFRAN, PARIS (FR); ONERA - OFFICE NATIONAL D'ETUDES ET DE RECHERCHES AEROSPATIALES, PALAISEAU (FR)

(72) Inventors: Anne-Laure ROUFFIE, MOISSY-CRAMAYEL (FR); Jean-Michel Patrick Maurice FRANCHET, MOISSY-CRAMAYEL (FR); Edern MENOU, MOISSY-CRAMAYEL (FR); Didier LOCQ, PALAISEAU (FR)

(21) Appl. No.: 18/847,589

(22) PCT Filed: Mar. 14, 2023
(86) PCT No.: PCT/FR2023/050333

§ 371 Date: Sep. 16, 2024

(30) Foreign Application Priority Data
Mar. 17, 2022 (FR) FR2202333

(51) Int. Cl. C22C 19/05; C22F 1/00; C22F 1/10

(52) U.S. Cl. CPC C22C 19/056; C22F 1/002; C22F 1/10

(57) ABSTRACT

A nickel-based superalloy, includes, in percent by weight of the total composition Al 2.5-3.8, Co 7.9-16.9, Cr 9.7-13.1, Mo 2.6-4.1, Nb 0-0.41, Ta 0-1.9, Ti 4.4-6.4, W 1.9-4.2, B 0.010-0.030, C 0.010-0.040, Hf 0.20-0.40, Zr 0.040-0.070, the remainder being Ni together with inevitable impurities.

### TECHNICAL FIELD

The present invention relates to the field of nickel-based superalloys for high temperature applications and developed for a turbine disk application with a dual coarse-grain/fine-grain structure. Increasing engine performance and reducing their specific consumption requires an increase in their operating temperature. This translates into the need to have new materials that are ever more resistant to heat. For turbine disks, the target temperatures are of the order of 800° C. in nominal operation with temporary peaks of up to 850° C. in the rim of the disk, that is to say near the blades. In addition, the alloy must also be very resistant in traction and fatigue in the area close to the disk bore, because it is subjected to high stresses when the complete disk+turbine blade system is rotating, but at lower temperatures (below 700° C.). These specifications can be achieved by combining two routes: on the one hand the method route, which comprises, among others, a development of the alloy by powder metallurgy and the application of a dual structure heat treatment (patent FR3043410B1) allowing to optimize the grain size both in the rim and in the bore of the disk, and on the other hand the material route which allows to have a chemical composition directly adapted to this method and to achieve a significant gain on mechanical properties.

### PRIOR ART

The specifications indicated above can be achieved by combining two routes:
on the one hand the method route, which comprises, among others, the development of the alloy by powder metallurgy and the application of a heat treatment with a dual structure (patent FR3043410B1) allowing to optimize the grain size at the same time in the rim and in the disk bore;
and on the other hand the material route which allows to have a chemical composition directly adapted to this method and to achieve a significant gain in mechanical properties.

Thus the heat treatment method allowing to obtain alloys having such a dual structure is known, as described in patent application FR3043410. This application presents a method for producing structural gradients on a disk-type part via a gradient heat treatment itself. This is an induction heat treatment which allows to carry out a solution treatment at a staged temperature in the part in such a way that:
in the hotter area, the temperature is higher than the dissolution temperature of the phase blocking the grain boundaries, also called solvus temperature (for gamma-gamma prime nickel base alloys, the phase in question is the gamma prime phase).
in the cooler area, the temperature is lower than this solvus temperature.

Thus, in the areas whose heat treatment temperature will exceed the solvus temperature of the gamma prime phase, the grains will grow to form a structure favorable to creep and cracking properties, while in areas whose heat treatment temperature will remain below the solvus temperature, the structure will retain the grain size resulting from forging which is generally relatively fine and favorable for tensile and fatigue properties.

In general, the application of a gradient treatment is carried out on an existing “conventional” alloy whose chemical composition has been optimized to achieve, with a homogeneous structure over the entire part, the best compromise of mechanical properties required. Thus the most efficient superalloys for disks have a target operating temperature of 760° C., with possible peaks at 800° C. However, existing chemical compositions are not optimal for configuring a gradient treatment.

Improving the performance of the part therefore requires defining a chemical composition specific to a gradient treatment of the part.

A nickel-based alloy composition was jointly defined by Safran Tech and ONERA to provide a first response to this problem (patent application FR3104613A1). This alloy has been specifically designed for a turbine disk application with a dual structure, where the grain size is optimized according to the mechanical characteristics required in each area of the part: the bore has a fine grain microstructure to optimize its resistance in traction and its fatigue life, while the rim has a larger grain microstructure to optimize its resistance to creep and crack propagation. The coarse-grained microstructure is obtained through local supersolvus γ′ (gamma prime) heat treatment. This alloy has a density of 8.24 g/cm³, which is rather low compared to other known alloys (8.34 g/cm³ for the powder metallurgy alloy N19) and therefore very interesting for this type of application. However, this composition has a relatively narrow supersolvus γ′ (gamma prime) heat treatment window: there is only about ten degrees of difference between the solvus γ′ (gamma prime) and the solidus of the alloy. From an industrial point of view, this heat treatment is feasible but the margin for error is small. In addition, even if the creep resistance at 850° C. of this alloy is very interesting, there are levers to optimize it in order to further increase the lifespan of the parts at this extreme temperature.

Another nickel-based alloy composition was already known from the prior art (application EP1840232) with higher niobium contents. However, their higher Nb content does not allow the precipitation of M23C6 carbides at a temperature of 850° C. which remain stable up to 900° C. or even 920° C. because Nb lowers the solvus temperature of these carbides below 900° C., or even below 800° C. However, such carbides improve the creep resistance of the alloy.

### DESCRIPTION OF THE INVENTION

The inventors surprisingly discovered that it was possible to obtain such properties using a nickel-based superalloy which could possibly contain tantalum but in a limited content and containing lower contents of niobium than the alloy described in FR3104613 and in EP1840232 and in particular than the most efficient alloy marketed (N19/SMO43).

The present invention therefore relates to a nickel-based superalloy, characterized in that its composition comprises, advantageously consists essentially of, in particular consists of, in percent by weight of the total composition:
Aluminum: 2.5-3.8, advantageously 2.8-3.5;
Cobalt: 7.9-16.9, advantageously 8.2-16.6;
Chromium: 9.7-13.1, advantageously 10.0-12.8;
Molybdenum: 2.6-4.1, advantageously 2.6-3.8;
Niobium: 0-0.41;
Tantalum: 0-1.9, advantageously 0-1.8;
Titanium: 4.4-6.4, advantageously 4.6-6.1;
Tungsten: 1.9-4.2, advantageously 2.2-4.0;
Boron: 0.010-0.030, advantageously 0.010-0.020;
Carbon: 0.010-0.040, advantageously 0.015-0.035;
Hafnium: 0.20-0.40, advantageously 0.20-0.35;
Zirconium: 0.040-0.070, advantageously 0.045-0.065;
The remainder being Nickel
together with inevitable impurities;
with 12.5≤Al+Ti+Nb+Ta≤14% at., the contents of these elements being expressed in atomic percentages;
with 0.85≤Al/(Ti+Nb+Ta)≤1.2, the contents of these elements being expressed in atomic percentages; and
with Mo+W≥2.5% at., the contents of these elements being expressed in atomic percentages.

The composition of the nickel-based superalloy according to the invention therefore contains the following elements:
Major addition elements: Co, Cr, Mo, W, Al, Ti, Ta;
Minor addition elements (concentration less than mass percent): Hf, C, B, Zr, Nb.

The composition according to the invention thus comprises, in % by weight relative to the total weight of the composition, aluminum (Al) in a content comprised in the range 2.5-3.8, advantageously 2.8-3.5, in particular 2.82-3.43, more particularly 2.9-3.3. The aluminum content is measured with an uncertainty of ±0.10.

The composition according to the invention further comprises, in % by weight relative to the total weight of the composition, cobalt (Co) in a content comprised in the range 7.9-16.9, advantageously 8.2-16.6, in particular 8.2-15.6, more particularly 12.0-14.0. The cobalt content is measured with an uncertainty of ±0.4.

The composition according to the invention further comprises, in % by weight relative to the total weight of the composition, chromium (Cr) in a content comprised in the range 9.7-13.1, advantageously 10.0-12.8, in particular 10.8-12.8, more particularly 10.9-12.7, even more particularly 11.65-12.7. The chromium content is measured with an uncertainty of ±0.35.

The composition according to the invention further comprises, in % by weight relative to the total weight of the composition, molybdenum (Mo) in a content comprised in the range 2.6-4.1, advantageously 2.6-3.8, in particular 2.7-3.25. The molybdenum content is measured with an uncertainty of ±0.11.

The composition according to the invention further comprises, in % by weight relative to the total weight of the composition, niobium (Nb) in a content comprised in the range 0-0.41. In an advantageous embodiment, the composition is free of niobium. In another advantageous embodiment, the composition contains niobium in an amount of at most 0.41% (in % by weight relative to the total weight of the composition), in particular in the range 0.39-0.41%, more specifically 0.40-0.41%. The niobium content is measured with an uncertainty of ±0.10.

The composition according to the invention further comprises, in % by weight relative to the total weight of the composition, tantalum (Ta) in a content comprised in the range 0-1.9, advantageously 0-1.8. In an advantageous embodiment, the composition is free of tantalum. Indeed, tantalum (Ta) contributes to the reinforcement of the gamma prime phase but has the effect of increasing the density of the alloy. In another advantageous embodiment, the composition contains tantalum in an amount of at most 1.9% (in % by weight relative to the total weight of the composition), in particular at most 1.6%, more particularly in the range 1-1.6%. The tantalum content is measured with an uncertainty of ±0.15.

The composition according to the invention further comprises, in % by weight relative to the total weight of the composition, titanium (Ti) in a content comprised in the range 4.4-6.4, advantageously 4.6-6.1. The titanium content is measured with an uncertainty of ±0.15.

The composition according to the invention further comprises, in % by weight relative to the total weight of the composition, tungsten (W) in a content comprised in the range 1.9-4.2, advantageously 2.2-4.0. The tungsten content is measured with an uncertainty of ±0.16.

The composition according to the invention also comprises, in % by weight relative to the total weight of the composition, boron (B) in a content comprised in the range 0.010-0.030, in particular 0.010-0.020. The boron content is measured with an uncertainty of ±0.003.

The composition according to the invention also comprises, in % by weight relative to the total weight of the composition, carbon (C) in a content comprised in the range 0.010-0.040, advantageously 0.015-0.035, in particular 0.020-0.035. The carbon content is measured with an uncertainty of ±0.003.

The composition according to the invention further comprises, in % by weight relative to the total weight of the composition, hafnium (Hf) in a content in the range 0.20-0.40, advantageously 0.20-0.35. The hafnium content is measured with an uncertainty ±0.002.

The composition according to the invention further comprises, in % by weight relative to the total weight of the composition, zirconium (Zr) in a content in the range 0.040-0.070, advantageously 0.045-0.065, in particular 0.055-0.060. The zirconium content is measured with an uncertainty of ±0.003.

The nickel-based alloy according to the invention contains the elements cobalt, aluminum, titanium, niobium and tantalum intended to form a hardening γ′ (gamma prime) precipitation of ordered structure L1₂ and of composition (Ni,Co)₃(Al,Ti,Nb,Ta). The tantalum content is however limited in order to avoid excessively increasing the density of the alloy, the target of which is less than or equal to 8.30 g/cm³.

The niobium content is limited to 0.41% by weight because this element stabilizes the MC carbides (with M=Ti, Nb) to the detriment of the M₂₃C₆ carbides (with M=Cr, Mo or W). The presence of a too high amount of niobium results in a lowering of the solvus temperature of the M₂₃C₆ carbides below 900° C. The minimum solvus value of the M₂₃C₆ carbides is thus advantageously fixed at 900° C. (solvus M₂₃C₆≥900° C.), preferably at 920° C. (solvus M₂₃C₆≥920° C.), in order to ensure their stability at 850° C. and maintain a margin in the event of a future increase in temperature peaks of the disks in operation.

Carbon, boron, zirconium and hafnium reinforce the resistance of grain boundaries at high temperatures. Carbon also allows to form the carbides M₂₃C₆ (with M=Cr, Mo or W).

Molybdenum and tungsten contribute to the hot mechanical reinforcement of the alloy. Their contents are optimized to maximize this reinforcement while limiting the precipitation of TCP (Topologically Close Packed) phases of the σ or μ type, which can degrade the mechanical resistance. These elements also participate in the formation of carbides M₂₃C₆ (with M=Cr, Mo or W). In particular, the presence of W participates in the formation and stabilization of carbides M₂₃C₆. The sum of their contents expressed in atomic percentages must respect the rule Mo+W≥2.5% at. (the contents of these elements being expressed in atomic percentages) in particular to ensure a minimum of reinforcement by solid solution of the γ (gamma) matrix.

Chromium is present because it participates in the formation of carbides M₂₃C₆ (with M=Cr, Mo or W) and allows to improve the oxidation resistance of the alloy via the formation of a continuous passivation layer on the surface. Its content is however limited to avoid promoting the precipitation of the TCP phases of which it is part.

The hot mechanical resistance of the alloy is favored by a molar fraction of γ′ (gamma prime) precipitates comprised between 50% and 56%. The elements Al, Ti, Nb and Ta expressed in atomic percentages respect the criterion 12.5≤Al+Ti+Nb+Ta≤14% at. In order to favor the precipitation of the γ′ (gamma prime) phase compared to the η-Ni₃Ti phase, which is undesirable from the point of view of mechanical properties, the elements Al, Ti, Nb and Ta respect the criterion 0.85≤Al/(Ti+Nb+Ta)≤1.2, the contents of these elements being expressed in atomic percentages. These criteria mean that it is desired to optimize the contents of titanium, niobium and tantalum in the γ′ (gamma prime) phase to maximize the hot mechanical reinforcement of the alloy, while avoiding promoting the formation of the phase n to the detriment of γ′ (gamma prime).

The unavoidable impurities of the composition according to the invention come from the steps of manufacturing the superalloy or from the impurities present in the raw materials used for the manufacture of the superalloy. All the conventional impurities encountered are found in nickel-based superalloys. In particular they are chosen from the group consisting of manganese, silicon, vanadium, sulfur, phosphorus, copper, lead, iron, bismuth, nitrogen, oxygen, hydrogen and mixtures thereof. They can constitute up to 1% by weight of the alloy and each represent no more than 0.5% by weight of the total composition. Generally, the content of impurities in the alloy is measured with an uncertainty of 10%.

In an advantageous embodiment, the nickel-based superalloy according to the invention is characterized in that its composition comprises, advantageously consists essentially of, in particular consists of, in percent by weight of the total composition:
Aluminum: 2.8-3.5;
Cobalt: 8.2-15.6;
Chromium: 10.8-12.8;
Molybdenum: 2.7-3.25;
Niobium: 0-0.41;
Tantalum: 0-1.9;
Titanium: 4.6-6.1;
Tungsten: 2.2-4.0;
Boron: 0.010-0.030, advantageously 0.010-0.020;
Carbon: 0.010-0.040, advantageously 0.015-0.035;
Hafnium: 0.20-0.40, advantageously 0.20-0.35;
Zirconium: 0.040-0.070, advantageously 0.045-0.065;
The remainder being Nickel
together with inevitable impurities;
with 12.5≤Al+Ti+Nb+Ta≤14% at., the contents of these elements being expressed in atomic percentages;
with 0.85≤Al/(Ti+Nb+Ta)≤1.2, the contents of these elements being expressed in atomic percentages; and
with Mo+W≥2.5% at., the contents of these elements being expressed in atomic percentages.

In particular, the composition of the superalloy according to the present invention can be as indicated in the following Table 1.

TABLE 1

| Comp. | | | | | | | | | | | | | |
|---|---|---|---|---|---|---|---|---|---|---|---|---|---|
| % mass | Ni | Al | Co | Cr | Mo | Nb | Ta | Ti | W | B | C | Hf | Zr |
| Ex 1 | bal. | 2.93 | 8.2 | 11.7 | 3.33 | 0.40 | 0 | 4.99 | 3.83 | 0.015 | 0.02 | 0.31 | 0.057 |
| Ex 2 | bal. | 3.43 | 15.5 | 10.0 | 3.37 | 0 | 0 | 5.67 | 3.07 | 0.015 | 0.02 | 0.31 | 0.057 |
| Ex 3 | bal. | 3.32 | 16.6 | 11.0 | 3.80 | 0 | 0 | 5.27 | 2.27 | 0.015 | 0.02 | 0.31 | 0.057 |
| Ex 4 | bal. | 3.42 | 14.4 | 10.0 | 2.94 | 0 | 0 | 5.65 | 3.86 | 0.015 | 0.02 | 0.31 | 0.057 |
| Ex 5 | bal. | 3.19 | 10.3 | 11.8 | 3.36 | 0.41 | 0 | 5.03 | 3.06 | 0.015 | 0.02 | 0.31 | 0.057 |
| Ex 6 | bal. | 3.05 | 14.4 | 11.8 | 3.34 | 0 | 0 | 5.00 | 3.84 | 0.015 | 0.03 | 0.31 | 0.057 |
| Ex 7 | bal. | 2.94 | 14.4 | 12.7 | 2.93 | 0 | 0 | 5.22 | 3.85 | 0.015 | 0.03 | 0.31 | 0.057 |
| Ex 8 | bal. | 3.18 | 13.4 | 11.8 | 2.93 | 0 | 0 | 5.23 | 3.86 | 0.015 | 0.03 | 0.31 | 0.057 |
| Ex 9 | bal. | 3.15 | 13.2 | 11.7 | 2.90 | 0 | 1.56 | 4.76 | 3.81 | 0.014 | 0.03 | 0.25 | 0.057 |
| Ex 10 | bal. | 2.95 | 8.2 | 12.7 | 3.35 | 0.41 | 0 | 5.02 | 3.05 | 0.015 | 0.03 | 0.31 | 0.057 |
| Ex 11 | bal. | 3.33 | 12.5 | 11.0 | 3.80 | 0 | 0 | 5.27 | 2.27 | 0.015 | 0.03 | 0.31 | 0.057 |
| Ex 12 | bal. | 2.95 | 12.4 | 10.9 | 3.36 | 0 | 0 | 6.07 | 3.06 | 0.015 | 0.03 | 0.31 | 0.057 |
| Ex 13 | bal. | 2.82 | 8.2 | 12.7 | 2.93 | 0 | 0 | 5.42 | 3.85 | 0.015 | 0.03 | 0.31 | 0.057 |
| Ex 14 | bal. | 3.42 | 8.2 | 10.9 | 2.94 | 0.41 | 0 | 5.44 | 3.86 | 0.015 | 0.03 | 0.31 | 0.057 |
| Ex 15 | bal. | 3.05 | 9.2 | 12.7 | 3.34 | 0.40 | 0 | 4.79 | 3.84 | 0.015 | 0.03 | 0.31 | 0.057 |
| Ex 16 | bal. | 3.2 | 15.6 | 11.9 | 3.80 | 0 | 0 | 5.05 | 2.26 | 0.015 | 0.03 | 0.31 | 0.057 |
| Ex 17 | bal. | 2.82 | 10.3 | 10.9 | 2.92 | 0 | 0 | 5.62 | 3.84 | 0.015 | 0.03 | 0.31 | 0.057 |

Hot creep resistance is reinforced by the precipitation of M₂₃C₆ carbides in the grain boundaries, with M=Cr, Mo or W. These carbides precipitate discreetly during tempering operations carried out at temperatures less than or equal to 870° C., preferably less than or equal to 850° C. for a period comprised between 2 h and 16 h, and have a size less than 5 μm, preferably less than 1 μm. The amount of carbides M₂₃C₆ (with M=Cr, Mo or W) calculated using the CALPHAD (CALculation of PHAse Diagrams) method is advantageously comprised between 0.4% and 1% mole at 850° C. (0.4%<M₂₃C₆<1 molar % at. 850° C.), preferably between 0.5% and 0.8 molar % at. 850° C. (0.5%<M₂₃C₆<0.8 molar % at. 850° C.), in order to obtain a population of carbides sufficient to ensure the desired hardening while avoiding saturating the grain boundaries, which would then promote undesired intragranular precipitation and weaken the alloy. The solvus temperature of the carbides M₂₃C₆ (with M=Cr, Mo or W) is advantageously greater than 900° C. in order to avoid dissolving the carbides back in the event of temperature peaks above 850° C. in operation, and preferably greater than 920° C. in order to compensate for a possible future increase in temperature at the time of these peaks.

In an advantageous embodiment, the superalloy according to the invention has a density of less than 8.50 g/cm³, advantageously less than 8.30 g/cm³. The room temperature density of each superalloy was estimated using a modified version of the Hull formula. This empirical equation was proposed by Hull (FC Hull, Metal Progress, November 1969, pp 139-140). The empirical equation is based on the law of mixtures and comprises corrective terms deduced from a linear regression analysis of experimental data (chemical compositions and measured densities) concerning 235 superalloys and stainless steels. This Hull formula was modified based on data relating to 272 nickel-based, cobalt-based and iron-based superalloys. The modified Hull formula is as follows:

$$D \cdot = \cdot 100 \cdot / \cdot [ \sum \cdot ( \% X / DX ) ] \cdot + \cdot \sum \cdot AX \cdot x \cdot \% X \qquad [ Math . 1 ]$$

where DX are the densities of the elements X (Cr, Ni, etc.), and D is the density of the superalloy, the densities being expressed in g/cm³, where AX is a coefficient expressed in g/cm³ of the elements X (Cr, Ni, etc.), and are as follows: ANi=−0.0011; AAl=0.0622; ATa=0.0121; ATi=0.0317; ANb=0.011; ACo=−0.0001; ACr=−0.0034; AMo=0.0033; AW=0.0033; AHf=0.0156, and where % X are the contents, expressed in mass percentages, of the elements X of the superalloy (Cr, Ni, etc.).

In another advantageous embodiment, the superalloy according to the invention has a metallurgical stability (that is to say an absence of TCP phases—Topological Compact Phases) up to 800-850° C.

In yet another advantageous embodiment, the superalloy according to the invention has good resistance to oxidation.

In yet another advantageous embodiment, the superalloy according to the invention has a difference between the solidus temperature γ (gamma) and the solvus temperature γ′ (gamma prime) which is sufficiently large for carrying out the heat treatment, advantageously a difference at least 20° C. ([solidus γ−solvus γ′]≥20° C.).

In an advantageous embodiment, the nickel-based superalloy according to the invention is free of tantalum and/or niobium, advantageously tantalum and niobium.

In another advantageous embodiment, the nickel-based superalloy according to the invention comprises tantalum and/or niobium.

The present invention further relates to the superalloy powder according to the invention. Indeed, the superalloy according to the invention can be found in the form of a powder with a particle size comprised between 10 μm and 100 μm.

The present invention further relates to a method for manufacturing a nickel-based superalloy powder according to the invention comprising the following steps:
A—mixing elementary or pre-alloyed raw materials;
B—melting the mixture obtained in step A), advantageously in a vacuum induction furnace (VIM);
C—atomizing with gas, advantageously with argon, the product obtained in step B) so as to obtain a powder, which is advantageously mainly spherical (that is to say without sharp angles);
D—sieving the powder obtained in step C), advantageously under an inert atmosphere, so as to obtain the targeted particle size;
E—recovering the powder obtained.

The method can further have the following successive steps, after step E:
F—containerizing the powder (in particular a cylindrical container, more particularly under vacuum);
G—hot pressing the filled container, for example by Hot Uniaxial Pressing (HUP) in a press, or by Hot Isostatic Pressing (HIP), in particular in an autoclave;
H—hot spinning the powder container (the container passes through a die which reduces its diameter. It is thus possible to obtain a cylindrical bar with a 100% dense, fine and homogeneous structure),
I—peeling (to remove the peripheral sheath corresponding to the walls of the initial container) and control operations, in particular by ultrasound;
J—cutting into sections.

The particle size of the powder is thus adapted according to the manufacturing technology of the parts based on superalloy powder considered. The particle size ranges used for the different manufacturing methods vary depending on the technology, equipment and targeted applications. In general, if all the applications are combined, the powder used for these methods will have more or less wide particle size distributions between 10 μm and 100 μm.

The present invention further relates to a method for manufacturing a part, in particular turbines, made of superalloy according to the invention or superalloy powder according to the invention, characterized in that it comprises the following steps:
a—forging,
b—gradient heat treatment of the part obtained in step a),
c—final heat treatment of the entire part with dual microstructure obtained in step b)
d—recovery of the part obtained in step c).

The forging step a) can be implemented by methods well known to the person skilled in the art, in particular on the sections obtained in step J. It can for example be a stamping (such as for example isothermal forging). This technique is well known to the person skilled in the art. This step a) allows to obtain a superalloy part.

The gradient heat treatment step b) can be implemented using the method and device described in patent application FR3043410.

Advantageously, the step b) of gradient heat treatment of the part obtained in step a) includes:
b1—a first heating of an area of the part to a first temperature (T1) higher than the solvus temperature of the gamma prime phase of said superalloy and lower than the melting temperature of said superalloy.

It can thus include heating an area of the part (for example the rim of the disk) to a first temperature (T1) higher by at least 5° C. than the solvus temperature of the gamma prime phase of said superalloy (advantageously between +5° C. and +15° C. relative to the solvus temperature of the gamma prime phase of said superalloy) and lower than the melting temperature of said superalloy (it is therefore a supersolvus treatment that is to say a supersolvus dissolution). The duration of this treatment can be comprised between 1 hour and 8 hours.

The gradient heat treatment can for example be carried out by local induction heating or by any method or device described in FR3043410.

In the case where the part is a turbine disk, the area of the part undergoing the first temperature (T1) consists of the rim area of the disk, the rest of the part not being impacted by this treatment.

Thus the supersolvus treatment (temperature T1) allows to use 100% of the hardening potential associated with the gamma prime phase to maintain hardening that is still effective at high temperatures (800° C. and even able to withstand peaks at 850° C.), while by increasing the grain sizes to improve the resistance of the alloy to hot creep and crack propagation. The grain size is thus advantageously greater than or equal to 15 μm (measured by the intercept method). The grain size is advantageously 40 μm on average to maintain good fatigue resistance.

Step b) therefore allows to obtain a part with a dual or gradient microstructure, that is to say not having a homogeneous microstructure, in particular whose grain size is not the same, depending on whether the area of the part which has undergone the supersolvus treatment or that which has not been impacted by the supersolvus treatment is considered. Thus the area of the part having undergone the supersolvus treatment contains large grains and that which has not been impacted by the supersolvus treatment contains fine grains. The part with a dual or gradient microstructure according to the invention therefore contains large grains and fine grains, advantageously large grains having a size greater than or equal to 15 μm, in particular in the area of the part having undergone the supersolvus treatment, for example in the rim of the disk, and fine grains, in particular from forging, having a size less than 15 μm, in particular in the area of the part which has not been impacted by the supersolvus treatment, for example in the disk bore. The grain size is measured by the intercept method.

Step c) of the method according to the invention may comprise the following successive steps:
c1—placing the entire part obtained in step b) in solution at a temperature lower than the solvus temperature of the gamma prime phase of said superalloy (T2) (it is therefore a subsolvus treatment or subsolvus solution), for example at a temperature T2 comprised between −80° C. and −20° C. relative to the solvus of the gamma prime phase;
c2—cooling or quenching the entire part obtained in step c1);
advantageously the cooling speed is adapted to the massiveness of the part in order to obtain an optimal size and distribution of the gamma prime hardening phase, more advantageously it is of the order of 100° C./min (the speed can vary from 80 to 120° C./min depending on the location).
c3—at least one tempering treatment of a portion or all the part obtained in step c2), advantageously at a temperature in the range 730° C.-870° C., so as to precipitate carbides of type M₂₃C₆ with M=Cr, Mo or W.

The final heat treatment of step c) is therefore the conventional heat treatment of gamma/gamma prime alloys. The objective of this treatment is to treat the structure not impacted by the gradient treatment in order to have, in these areas, a final structure and therefore mechanical properties equivalent to the desired level. Indeed, in the area treated only in subsolvus (temperature T2), the grain size remains small, advantageously less than 10 μm (measured by the intercept method), which allows to obtain good traction and fatigue properties at average temperatures, for example below 750° C. This second solution thus allows to refine the size of the γ′ (gamma prime) precipitates throughout the part, while maintaining a fine grain size in the areas which did not undergo the first solution. The part obtained thus has a grain size of 6-7 ASTM (28-40 μm) in the rim intended to be subjected to creep at very high temperatures, and a grain size of 10-12 ASTM (5-10 μm) in the rest of the part which is mainly stressed in traction and fatigue at lower temperatures.

The duration of step c1) can be comprised in the range 1 hour-8 hours. In particular, step c3) may consist of one or more tempering treatments, advantageously two tempering treatments. This can be a single-tier or dual-tier tempering treatment.

Thus, a relatively hot final tempering treatment (for example in the range 730° C.-870° C., in particular 730° C.-850° C., for example a first tempering at a temperature around 850° C., more particularly 850° C., followed by a second tempering at a temperature comprised between 730° C. and 800° C., advantageously around 800° C., in particular 800° C., allows to stabilize the microstructure of the part at high temperature also allows to relax the residual stresses resulting from the quenching associated with the treatment at temperature T2.

The duration of step c3) can be in the range 2 hours-24 hours (for example a first temper for a duration of 4 hours-8 hours, in particular at a temperature of 850° C., followed by a second tempering for a duration of 4 hours-16 hours, particularly at a temperature of 800° C.).

The tempering and quenching treatments are carried out using techniques well known to the person skilled in the art.

The tempering heat treatments are intended to precipitate M₂₃C₆ type carbides with M=Cr, Mo or W and to stabilize the populations of γ′ (gamma prime) precipitates. Thus the first tempering treatment is carried out to precipitate carbides M₂₃C₆ with M=Cr, Mo or W in nodular form and the second tempering treatment is carried out to stabilize the population of precipitates γ′ (gamma prime) at a temperature close to the target operating temperature for the hottest portion of the disk.

These thermal tempering treatments can be carried out homogeneously over the entire part, but it is also possible to treat only part of the part in order to optimize the tempering according to the characteristics targeted in each area. For example, only the area of the part having undergone the supersolvus treatment such as the rim of the disk can be treated at a tempering temperature around 850° C. (advantageously 850° C.) to precipitate the carbides M₂₃C₆, before treating the entire part at a temperature comprised between 730° C. and 800° C. to stabilize the precipitation γ′ (gamma prime) in the bore of the part. This allows to optimize the resistance to creep in the rim thanks to the precipitation of the M₂₃C₆ carbides at 850° C., but without causing the precipitates to increase γ′ in the bore of the disk and thus to preserve the finest possible γ′ precipitates in order to optimize the tensile strength of this area.

The present invention finally relates to a part made of superalloy according to the present invention or of superalloy powder according to the present invention, having a dual microstructure, advantageously capable of being obtained by the method according to the present invention. Advantageously it is a turbomachine part, more advantageously a turbine part, in particular a turbine disk, a compressor disk, a ring, a flange, or a turbine casing, more particularly of a turbine disk, for example of aircraft and/or helicopter engines.

The part according to the invention therefore has a dual or gradient microstructure, that is to say it does not have a homogeneous microstructure. In particular, the grain size of the part is not the same depending on the area of the part. Therefore, it contains large grains and fine grains, advantageously large grains having a size greater than or equal to 15 μm, advantageously 40 μm on average, and fine grains having a size less than 15 μm. Thus advantageously one area of the part contains large grains and the rest of the part and/or another area of the part contains fine grains. Thus, in the case where the part is a turbine disk, the rim area of the disk is coarse grained, advantageously having grains with a size greater than or equal to 15 μm, advantageously 40 μm on average, and the area of the bore of the disk is fine grained, advantageously having grains having a size less than 15 μm. The grain size is measured by the intercept method.

Advantageously, the large grain area of the part has good creep resistance according to standard NF EN ISO 24 Aug. 2009 at a temperature of 850° C., more advantageously a duration greater than 37 hours, at 0.2% elongation under a stress of 200 MPa and a temperature of 850° C.

Advantageously, the fine-grained area of the part has good tensile strength according to Standard NF EN 2002-001/06 at a temperature below 750° C., in particular an elastic limit at 20° C. greater than 1100 MPa. The present invention will be better understood in light of the description of the figures and examples which follow. The examples are given in an indicative, non-limiting manner.

### BRIEF DESCRIPTION OF THE DRAWINGS

FIG. 1 shows the diagram of a forged disk having a gradient microstructure, with large grains of 28-40 μm in the rim and small grains of 5-10 μm in the rest of the part. The transition area between the two microstructures is shown schematically by dotted lines.

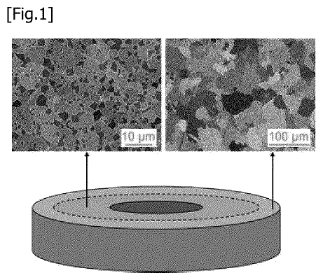

### EXAMPLE

Nickel-based superalloys according to the invention (examples 1 to 8 and 10 to 17) were manufactured according to the following method: vacuum casting of an ingot, then atomization under argon of this ingot, sieving at 53 μm, placing containerized powders with degassing, then hot spinning of these powders in bar form. The nickel-based superalloy of Example 9 was produced by VIM casting, according to a method well known to the person skilled in the art. They were compared with 5 superalloys: 1 superalloy according to the example of application FR3104613 (ex FR3104613A1), 1 superalloy according to the example of application EP1840232 (ex EP1840232) and 3 superalloys having too high niobium contents (counter-examples 18 to 20)

The alloys manufactured according to the invention have the chemical composition in % by weight indicated in Table 1 above. The 5 comparative superalloys have the composition indicated in Table 2 below.

TABLE 2

| Compo | | | | | | | | | | | | | |
|---|---|---|---|---|---|---|---|---|---|---|---|---|---|
| % mass | Ni | Al | Co | Cr | Mo | Nb | Ta | Ti | W | B | C | Hf | Zr |
| EP1840232 | bal. | 2.48 | 11.8 | 12.9 | 4.66 | 1.57 | 0 | 3.82 | 3.21 | 0.017 | 0.02 | 0.30 | 0.060 |
| FR3104613 | bal. | 3.22 | 12.9 | 11.0 | 3.51 | 2.16 | 0 | 5.02 | 3.44 | 0.017 | 0.02 | 0.34 | 0.067 |
| Counter - | bal. | 3.05 | 8.2 | 10.8 | 2.92 | 1.21 | 0 | 5.61 | 3.83 | 0.015 | 0.03 | 0.31 | 0.057 |
| Ex 18 | | | | | | | | | | | | | |
| Counter - | bal. | 2.95 | 8.3 | 11.8 | 3.78 | 0.81 | 0 | 5.03 | 2.25 | 0.015 | 0.02 | 0.31 | 0.057 |
| Ex 19 | | | | | | | | | | | | | |
| Counter - | bal. | 3.18 | 9.3 | 11.8 | 3.35 | 1.22 | 0 | 4.80 | 3.05 | 0.015 | 0.03 | 0.31 | 0.057 |
| Ex 20 | | | | | | | | | | | | | |

The solvus γ′ (gamma prime) and solidus temperatures calculated for the different alloys and the solidus-solvus γ′ (gamma prime) difference are shown in Table 3 below. The density estimated using a modified version of Hull's formula as shown above is also shown in Table 3. The value of the formulas Al+Ti+Nb+Ta in % at. and Al/(Ti+Nb+Ta) in % at. is also shown in Table 3.

A part of the bar then underwent treatment at a temperature between 1180° C. and 1200° C. for a duration of 2 h (supersolvus treatment) then cooling at around 30° C./min. The entire bar then underwent treatment at a temperature between 1145° C. and 1165° C. for a duration of 2 h (subsolvus treatment) followed by quenching at a speed of 100° C./min and tempering at a temperature of 850° C. for a duration of 4 hours to 8 hours followed by a second tempering at a temperature of 800° C. for a duration of 4 hours to 16 hours. The amount of M₂₃C₆ carbides calculated using the CALPHAD (CALculation of PHAse Diagrams) method is shown in Table 3. The solvus temperature of M₂₃C₆ carbides is also shown in Table 3.

TABLE 3

| | | | | | | | Solidus − | |
|---|---|---|---|---|---|---|---|---|
| | | Al + Ti + | % mol. | Solvus | Solvus | | solvus γ′ | |
| | Al/(Ti + | Nb + Ta | M₂₃C₆ at | M₂₃C₆ | γ′ | Solidus | difference | Density |
| | Nb + Ta) | in % at. | 850° C. | (° C.) | (° C.) | (° C.) | (° C.) | (g/cm³) |
| EP1840232 | 0.95 | 11.0 | 0 | 779 | 1134 | 1234 | 100 | 8.34 |
| FR3104613 | 0.93 | 14.3 | 0 | 735 | 1188 | 1196 | 8 | 8.22 |
| Ex 1 | 1.00 | 12.5 | 0.41 | 909 | 1165 | 1231 | 66 | 8.24 |
| Ex 2 | 1.07 | 14.0 | 0.41 | 900 | 1188 | 1210 | 22 | 8.17 |
| Ex 3 | 1.12 | 13.3 | 0.40 | 903 | 1173 | 1216 | 43 | 8.15 |
| Ex 4 | 1.07 | 14.0 | 0.41 | 907 | 1189 | 1210 | 21 | 8.19 |
| Ex 5 | 1.08 | 13.0 | 0.42 | 901 | 1173 | 1228 | 55 | 8.18 |
| Ex 6 | 1.08 | 12.5 | 0.65 | 922 | 1159 | 1219 | 60 | 8.22 |
| Ex 7 | 1.00 | 12.5 | 0.66 | 930 | 1158 | 1210 | 52 | 8.21 |
| Ex 8 | 1.08 | 13.0 | 0.66 | 937 | 1169 | 1217 | 48 | 8.20 |
| Ex 9 | 1.08 | 13.0 | 0.65 | 934 | 1163 | 1228 | 65 | 8.29 |
| Ex 10 | 1.00 | 12.5 | 0.54 | 929 | 1164 | 1229 | 65 | 8.18 |
| Ex 11 | 1.12 | 13.3 | 0.64 | 937 | 1177 | 1227 | 50 | 8.14 |
| Ex 12 | 0.86 | 13.5 | 0.53 | 920 | 1179 | 1204 | 25 | 8.18 |
| Ex 13 | 0.92 | 12.5 | 0.67 | 981 | 1161 | 1219 | 58 | 8.20 |
| Ex 14 | 1.07 | 14.0 | 0.67 | 930 | 1192 | 1225 | 33 | 8.18 |
| Ex 15 | 1.08 | 12.5 | 0.54 | 924 | 1163 | 1229 | 66 | 8.21 |
| Ex 16 | 1.12 | 12.8 | 0.65 | 921 | 1164 | 1221 | 57 | 8.15 |
| Ex 17 | 0.89 | 12.8 | 0.51 | 924 | 1167 | 1219 | 52 | 8.23 |
| Counter-Ex 18 | 0.87 | 14.0 | 0.66 | 871 | 1193 | 1215 | 22 | 8.22 |
| Counter-Ex 19 | 0.96 | 12.8 | 0.40 | 881 | 1173 | 1232 | 59 | 8.17 |
| Counter-Ex 20 | 1.04 | 13.3 | 0.66 | 866 | 1179 | 1230 | 51 | 8.19 |

Compared to current solutions, in this case the FR3104613 alloy or the EP1840232 alloy, the advantages obtained by this invention are twofold: the first advantage is easier industrial implementation thanks to the widening of the heat treatment window of the grain coarsening which goes from 10° C. to 20° C. or more, and the second advantage is an increase in the lifespan of parts at very high temperatures (850° C.).

The alloys according to the invention have an improvement in creep resistance at 850° C. to increase the lifespan of the part with respect to creep. At this temperature, grain boundaries are considered the weak points of the microstructure. This is why grain size enlargement is used to reduce the density of grain boundaries and thus limit their impact. In this new alloy, this coarsening is also associated with a precipitation of M₂₃C₆ carbides in the grain boundaries. These carbides are intended to reinforce grain boundaries in order to limit creep-diffusion mechanisms and slow down metal deformation by creep, and thus allow parts to operate longer at 850° C.

1. A nickel-based superalloy, its having a composition that comprises, in percent by weight of the total composition:
Aluminum: 2.5-3.8;
Cobalt: 7.9-16.9;
Chromium: 9.7-13.1;
Molybdenum: 2.6-4.1;
Niobium: 0-0.41;
Tantalum: 0-1.9;
Titanium: 4.4-6.4;
Tungsten: 1.9-4.2;
Boron: 0.010-0.030;
Carbon: 0.010-0.040;
Hafnium: 0.20-0.40;
Zirconium: 0.040-0.070;
the remainder being Nickel
together with inevitable impurities;
with 12.5≤Al+Ti+Nb+Ta≤14% at., the contents of these elements being expressed in atomic percentages;
with 0.85≤Al/(Ti+Nb+Ta)≤1.2, the contents of these elements being expressed in atomic percentages; and
with Mo+W≥2.5% at., the contents of these elements being expressed in atomic percentages.

2. The nickel-based superalloy according to claim 1, wherein the composition comprises, in percent by weight of the total composition:
Aluminum: 2.8-3.5;
Cobalt: 8.2-15.6;
Chromium: 10.8-12.8;
Molybdenum: 2.7-3.25;
Niobium: 0-0.41;
Tantalum: 0-1.9;
Titanium: 4.6-6.1;
Tungsten: 2.2-4.0;
Boron: 0.010-0.030;
Carbon: 0.010-0.040;
Hafnium: 0.20-0.40;
Zirconium: 0.040-0.070;
the remainder being Nickel
together with inevitable impurities;
with 12.5≤Al+Ti+Nb+Ta≤14% at., the contents of these elements being expressed in atomic percentages;
with 0.85≤Al/(Ti+Nb+Ta)≤1.2, the contents of these elements being expressed in atomic percentages; and
with Mo+W≥2.5% at., the contents of these elements being expressed in atomic percentages.

3. The nickel-based superalloy according to claim 1, wherein a temperature difference [solidus γ−solvus γ′]≥20° C.

4. The nickel-based superalloy according to claim 1, wherein a carbide content M₂₃C₆ is 0.4%<M₂₃C₆<1 molar % at. 850° C., with M-Cr, Mo or W.

5. The nickel-based superalloy according to claim 1, wherein a solvus temperature of the carbides M₂₃C₆≥900° C., with M=Cr, Mo or W.

6. The nickel-based superalloy according to claim 1, wherein the nickel-based superalloy is free of tantalum and/or niobium.

7. The nickel-based superalloy according to claim 1, wherein the nickel-based superalloy comprises tantalum and/or niobium.

8. A powder of a superalloy according to claim 1.

9. A method for manufacturing a superalloy part according to claim 1, comprising the following steps:
a—forging,
b—gradient heat treatment of the part obtained in step a),
c—final heat treatment of the entire part with dual microstructure obtained in step b)
d—recovery of the part obtained in step c).

10. The method according to claim 9, wherein step b) of gradient heat treatment of the part obtained in step a) includes:
b1—a first heating of an area of the part to a first temperature (T1) higher than a solvus temperature of the gamma prime phase of said superalloy and lower than the melting temperature of said superalloy.

11. The method according to claim 9, wherein the final heat treatment step c) comprises the following successive steps:
c1—placing the entire part obtained in step b) in solution at a temperature lower than the solvus temperature of the gamma prime phase, of said superalloy;
c2—cooling or quenching the entire part obtained in step c1);
c3—at least one tempering treatment of a portion or all the part obtained in step c2) so as to precipitate carbides of type M₂₃C₆ with M=Cr, Mo or W.

12. A part made of superalloy according to claim 1, having a dual microstructure.

13. The part according to claim 12, wherein the part is a turbomachine part.

14. The nickel-based superalloy according to claim 1, wherein the composition comprises, in percent by weight of the total composition:
Aluminum: 2.8-3.5;
Cobalt: 8.2-16.6;
Chromium: 10.0-12.8;
Molybdenum: 2.6-3.8;
Niobium: 0-0.41;
Tantalum: 0-1.8;
Titanium: 4.6-6.1;
Tungsten: 2.2-4.0;
Boron: 0.010-0.020;
Carbon: 0.015-0.035;
Hafnium: 0.20-0.35;
Zirconium: 0.045-0.065.

15. The nickel-based superalloy according to claim 1, wherein the composition comprises, in percent by weight of the total composition:
Aluminum: 2.8-3.5;
Cobalt: 8.2-15.6;
Chromium: 10.8-12.8;
Molybdenum: 2.7-3.25;
Niobium: 0-0.41;
Tantalum: 0-1.9;
Titanium: 4.6-6.1;
Tungsten: 2.2-4.0;
Boron: 0.010-0.020;
Carbon: 0.015-0.035;
Hafnium: 0.20-0.35;
Zirconium 0.045-0.065.

16. The nickel-based superalloy according to claim 4, wherein the carbide content M₂₃C₆ is 0.5%<M₂₃C₆<0.8 mol % at. 850° C., with M=Cr, Mo or W.

17. The nickel-based superalloy according to claim 5, wherein the solvus temperature of the carbides M₂₃C₆≥920° C., with M=Cr, Mo or W.

18. The method according to claim 11, wherein the c3—at least one tempering treatment of a portion or all the part obtained in step c2 is at a temperature in the range 730° C.-870° C.

19. The part according to claim 13, wherein the part is a turbine part.

20. The part according to claim 19, wherein the turbine part is, a turbine disk, a compressor disk, a ring, a flange or a turbine casing.
